(19) United States
(12) Patent Application Publication
(10) Pub. No.: US 2026/0316524 A1
(43) Pub. Date: Oct. 15, 2026

(54) Safety Device for a Heat Pump Operated with a Flammable Refrigerant, in Particular Propane, Safety System and Vehicle

(71) Applicant: ZF Friedrichshafen AG, Friedrichshafen (DE)

(72) Inventors: Uwe Grossgebauer, Erlabrunn (DE); Daniel Bauer, Niederwerrn (DE); Sebastian Neugebauer, Gera (DE); Axel Rohm, Schonungen (DE); Stefan Holzinger, Theres (DE)

(21) Appl. No.: 19/483,127

(22) PCT Filed: Apr. 15, 2024
(86) PCT No.: PCT/EP2024/060109

§ 371 Date: Nov. 10, 2025

(30) Foreign Application Priority Data
May 10, 2023 (DE) 102023204334.3

(51) Int. Cl. B60H 1/32; C09K 5/04

(52) U.S. Cl. CPC B60H 1/3225; B60H 1/3229; C09K 5/042; B60H 2001/3269; C09K 2205/12

(57) ABSTRACT

A safety device for a heat pump operated with a flammable refrigerant, such as propane, includes a housing having an upper side, a lower side opposite the upper side, and at least one side wall connecting the upper side and the lower side. The heat pump is arrangeable within an interior space defined by the housing. The device further includes at least one mixing unit for supplying a gas to the flammable refrigerant escaping from the heat pump into the interior space to create a refrigerant-gas mixture, the gas comprising air. Additionally, the device includes an outlet arranged on the side wall of the housing and fluid-dynamically connected to the interior space, at least one of the gas and the refrigerant-gas mixture being releasable from the interior space via the outlet.

### CROSS-REFERENCE TO RELATED APPLICATION

The present application is related and has right of priority to German Patent Application No. 10 2023 204 334.3 filed on May 10, 2023 and is a nationalization of PCT/EP2024/060109 filed in the European Patent Office on Apr. 15, 2024, both of which are incorporated by reference in their entirety for all purposes.

### FIELD OF THE INVENTION

The invention relates generally to a safety device for a heat pump operated with a flammable refrigerant, to a safety system with such a safety device and a heat pump, and to a vehicle with such a safety device and/or such a safety system.

### BACKGROUND

For cooling different units of a vehicle, one or more coolants are used, which are conducted through correspondingly configured lines to the different units in order to cool and/or heat these. A heat pump is also needed in order to transmit thermal energy from the coolant with a low temperature to the coolant with a higher temperature. For this purpose, the heat pump has a refrigerant circuit with a refrigerant.

The refrigerant is liquid and/or gaseous at room temperature. In particular, in the case of gaseous combustible or flammable refrigerant, it must be ensured that, when the gaseous refrigerant escapes, for example in the case of a leak, a fire hazard and/or risk of explosion is minimized, in particular prevented. Such a refrigerant is, for example, propane (R-290), or butane (R-600, R-600a), or propylene (R-1270), or dimethyl ether (R-E170). For forming an ignitable mixture, a certain volume fraction of air is required, which, for R-290, is 2.12% to 9.35%. Spontaneous ignition takes place at 470° C. and higher. A safety device is therefore necessary to prevent or reduce these risks.

In addition to the safety aspect, an installation space aspect of the safety device is also to be taken into account, since it is advantageous in general to accommodate the different units of the vehicle and the heat pump in the vehicle in the most compact manner possible.

### SUMMARY OF THE INVENTION

One problem addressed by the present invention is that of providing a safety device, a safety system, and a vehicle, which improve or even eliminate one or more of the aforementioned disadvantages. In particular, one problem addressed by the present invention is to provide a particularly space-efficient safety device, which prevents the formation of an ignitable mixture and/or permits safe handling of the escaping refrigerant and/or refrigerant-gas mixture.

The problem is solved according to a first aspect by a safety device for a heat pump operated with a flammable refrigerant, in particular propane. The safety device includes a housing for accommodating the heat pump in such a way that the heat pump is arrangeable within an interior space formed in the housing, and at least one mixing unit, which supplies a gas, in particular air, to a flammable refrigerant escaping from the heat pump into the interior space. The safety device also includes an outlet, which is fluid-dynamically connected to the interior space and releases the gas and the refrigerant-gas mixture from the interior space. The housing has an upper side, a lower side opposite the upper side, and at least one side wall connecting the upper side and the lower side, wherein the outlet is arranged on the side wall and releases the gas and the refrigerant-gas mixture.

The outlet may, additionally or alternatively, release the refrigerant.

The flammable refrigerant may be a refrigerant which is already flammable in an unmixed state and/or is flammable after mixing with a gas, in particular air. The flammable refrigerant may be liquid and/or gaseous. The flammable refrigerant may be gaseous along predetermined first sections of the heat pump and liquid along predetermined second sections. In particular in the case of the refrigerant escaping from the heat pump, the refrigerant may be gaseous.

In a case in which the refrigerant escapes from the heat pump, for example during a leak, the refrigerant may mix with air present in the interior space. In particular, air may be conducted and/or supplied into the interior space using the mixing unit and/or at least one inlet valve mentioned in the following in such a way that the supplied air generates an overpressure and/or turbulence in the housing.

The housing may have air guiding units which guide an air flow of the supplied air in the interior space. In particular in such a way that a vortexing of the escaping refrigerant with the air is made possible. In addition, the supplied air may be conducted by the air guiding units to predetermined positions and/or regions in the interior space.

The heat pump may have one or more predetermined points, predetermined breaking points, and/or emergency venting, which, in the case of an elevated pressure of the refrigerant in the heat pump, give way, tear, break, and/or release the refrigerant, such that the refrigerant escapes at the predetermined point(s), the predetermined breaking point(s), and/or the emergency venting. The air guiding unit may conduct the gas, in particular the air, in a targeted manner to this/these point(s), this/these predetermined breaking point(s), and/or this/these emergency venting in order to achieve a dilution, in particular as quickly as possible.

Alternatively, or additionally, the safety device includes a line within the interior space for conducting the escaping refrigerant to the mixing unit, toward the outside of the housing, and/or to a catch basin of the safety device. The catch basin may collect the gas, the refrigerant, and/or the refrigerant-gas mixture. The refrigerant, gas, and/or refrigerant-gas mixture collected by the catch basin may then be mixed with the supplied air, in particular by the mixing unit.

The line and/or a collecting line of the safety device may conduct the escaping refrigerant into a quiescent zone, which may reduce a flow rate of the escaping refrigerant. Next, the safety device may mix the refrigerant having a reduced flow rate with the supplied air. For this purpose, a position of the quiescent zone may be arranged in the housing on the basis of an air flow.

The outlet may be arranged on the side wall in such a way that this is arranged at least partially, in particularly completely, in the quiescent zone.

Due to the guidance and/or supply of the air in a targeted manner by the mixing unit and/or the at least one second inlet valve, the escaping refrigerant may be mixed with air so quickly that ignitability is not produced and, thus, the gas may safely escape or the gas-air mixture may be discharged in any possible mixing ratio to the surroundings in a targeted and quick manner. The safety device may adjust a volumetric flow rate of the supplied air in such a way that the mixing is carried out within a predetermined period of time. The safety device may control the volumetric flow rate in an open loop on the basis of a concentration of the refrigerant in the interior space. The concentration may be determined by a gas sensor mentioned in the following.

It is also advantageous that the refrigerant cannot escape from the heat pump toward the outside in an uncontrolled manner and disperse, for example, in an interior space of the vehicle, but rather is collected within the housing. Due to the supply of the air, the refrigerant-air mixture may be mixed in such a way that a non-combustible refrigerant-air mixture is produced. As mentioned above, in the case of the refrigerant propane, a volume fraction of propane of 2.12% to 9.35% must be present, so that the refrigerant-air mixture is flammable. Accordingly, the safety device may supply the air in such a way that the volume fraction of propane is outside this flammable range, in particular below or above this.

In addition, the outlet is arranged on the side wall and is designed to release the gas and/or refrigerant-gas mixture. Due to the arrangement on the side, an improved ground clearance may be advantageously made possible when arranging the safety device in the vehicle, since a lower arrangement is possible in comparison to an outlet downwards and/or on the lower side. The outlet may be arranged on and/or in the side wall.

The outlet may release the gas and/or the refrigerant-gas mixture toward the outside laterally through the side wall. Alternatively, or additionally, the outlet releases the gas and/or the refrigerant-gas mixture in a target direction. The target direction may be lateral, in particular orthogonal with respect to the direction of gravity, and/or orthogonal with respect to a direction of extent of the side wall between the upper side and the lower side. Alternatively, or additionally, the target direction is di-rected upwards or downwards. Therefore, the gas and/or the refrigerant-gas mixture may be conductable initially laterally and then upwards or downwards. The outlet may include a line and/or be coupled to a line.

The mixing unit may be arranged above the outlet, in particular above on the side wall or on the upper side or on a further side wall of the safety device. The refrigerant and/or the refrigerant-gas mixture may be heavier than air, such that it is advantageous to supply the air into the interior space above the outlet.

The housing may have one or more interfaces for lines and/or connections, wherein the interfaces are, in particular, sealable, advantageously sealed in a gas-tight manner. Accordingly, air may be supplied only via the mixing unit and/or the at least one second inlet valve and the release may take place only via the outlet.

The housing is sealable, in particular sealable in a gas-tight manner.

The heat pump may be a heat pump of the vehicle.

The outlet, the mixing unit, and/or the at least one second inlet valve may have a flame-protection screen, in particular to prevent sources of ignition from entering the interior space. Alternatively, or additionally, the safety device includes a collecting device, which prevents sources of ignition, such as cigarette ends, from entering the housing. The collecting device may include or be a mesh or a flame-protection screen.

The refrigerant may be or include an R-290 propane refrigerant, butane (R-600, R-600a), propylene (R-1270), or dimethyl ether (R-E170), and/or a flammable refrigerant, which is per se flammable and/or is flammable when mixed with air.

The outlet may be arranged on a lower section, in particular a lowermost section, of the side wall. The housing has the upper side and the lower side, wherein the lower, in particular the lowermost, section of the side wall may be connected to the lower side, and the upper, in particular the uppermost, section of the side wall may be connected to the upper side. As viewed along the direction of gravity, the upper side may be arranged higher than the lower side. The outlet may be arranged on the lower, in particular the lowermost, section in such a way that a remaining section of the side wall is still arranged between the lower side and the outlet. The remaining section may be selected to be minimal. Alternatively, the outlet may be arranged in such a way that this is connected to the lower side, in particular forms an end section of the side wall, which is connected to the lower side.

The lower side may have a downward slope in such a way that the gas and/or the refrigerant-gas mixture is conductable along the lower side to the side wall, in particular to the outlet. Due to gravity, a supply to the outlet may therefore be provided due to the downward slope.

The lower side may be a base of the housing or form the base. Alternatively, the lower side may form a section of a side wall, which extends, for example in an arc shape, from the upper side to the side wall of the outlet.

The lower side may be connected to the side wall in such a way that the lower side terminates with the side wall, in particular of the outlet, in a point-like or lin-ear manner.

The lower side may be arcuate and/or planar at least in sections such that the gas and/or the refrigerant-gas mixture is conductable along the lower side to the side wall, in particular to the outlet.

The lower side may have a recess and/or a protrusion which terminates with the side wall, in particular of the outlet. The remaining part of the lower side may be planar and/or arcuate. The planar section of the lower side may be orthogonal with respect to the direction of gravity or arranged at an angle that is different from the orthogonal angle.

The housing may be at least partially in the shape of a cuboid, a cube, a prism, a pyramid, a five-, six-, or multi-sided prism, a cylinder, and/or a cone.

The upper side and the at least one side wall may be connected at a predetermined angle, in particular perpendicularly.

The at least one side wall and/or the upper side may be at least partially planar and/or arcuate.

The housing may have two or more, in particular four, side walls. The outlet may be arranged on one of the plurality of side walls. Features of the outlet and features of the side wall may be features of the two or more side walls. The safety device may include two or more outlets. When the housing has two or more side walls, the outlet may be arranged on a first side wall, in particular on a lower section of the first side wall. The lower side may be designed in such a way that this is connected to a second side wall of the two or more side walls in such a way that this terminates higher in comparison to the first wall. Accordingly, the downward slope may be formed.

The lower side may be in the shape of a funnel, in particular in such a way that the gas and/or the refrigerant-gas mixture is conductable to the outlet.

The mixing unit may include at least one first inlet valve and/or the safety device may include at least the second inlet valve. The mixing unit may be the first inlet valve. The first and/or the second inlet valve may enable and/or suppress a supply of the gas to the interior space.

The mixing unit, the first inlet valve, and/or the at least second inlet valve may be connectable on an outer side of the housing to an air duct. The air duct may be an air line which conducts exhaust air of the vehicle and/or relative wind. Alternatively, or additionally, the mixing unit, the first inlet valve, the at least second inlet valve, and/or the outlet have a fan and/or a blower for conveying air into the interior space or out of the interior space. Alternatively, or additionally, the safety device includes one or more fans within the housing.

The mixing unit, the first inlet valve, the second inlet valve, and/or the outlet may switch between a completely open state for supplying or discharging the air and a closed state for preventing the supply or discharge of air. Alternatively, or additionally, the mixing unit, the first inlet valve, the second inlet valve, and/or the outlet have one or more intermediate states between the completely open state and the closed state. For this purpose, these may have a restrictor, an orifice, and/or nozzle.

The safety device may convey a predetermined volume of the gas into the interior space. The predetermined volume may be selected in such a way that the non-flammable mixture is mixable when the refrigerant escapes or that a flammable mixture is produced. When the flammable mixture is permitted, the outlet may be controllable in an open loop in such a way that this releases the flammable mixture from the interior space in such a way that the mixture is mixed with air present outside of the interior space, in particular immediately after the release, such that a non-flammable mixture is produced as a result of the mixing with the outside air. Therefore, the non-flammable mixture may also be obtained in the event of a suddenly very high release quantity of the refrigerant and an, under some circumstances, limited supply of gas, in particular air, via the mixing unit and/or the second inlet valve. Thus, a further safety mechanism is present.

The mixing unit may be arranged on the upper section, in particular the uppermost section, of the side wall or on the upper side. Alternatively, or additionally, the at least second inlet valve is arranged on the upper section, in particular the uppermost section, of the side wall or on the upper side.

The safety device may include two, three, or more mixing units and/or inlet valves.

The mixing unit may include or be a nozzle, in particular a Venturi nozzle, which suctions off the escaping refrigerant and mix this with the gas, in particular in such a way that a non-combustible mixing ratio of the refrigerant-gas mixture is producible. The nozzle, in particular the Venturi nozzle, may conduct the refrigerant-gas mixture and/or the refrigerant to the outlet, in particular by a line provided for this purpose.

The safety device may also include the at least one gas sensor, which detects a concentration of the refrigerant and/or refrigerant in the refrigerant-gas mixture in the interior space. The safety device may control the supply of gas in an open loop into the interior space on the basis of the concentration of the gas and/or the refrigerant-gas mixture.

The gas sensor may be arranged inside the housing.

The gas may be air.

The safety device may adjust the supply of the gas into the interior space by the mixing unit and/or the second valve in such a way that a non-combustible refrigerant-gas mixture is producible. For this purpose, the safety device may take further parameters into account. Further parameters may be a ground speed of the vehicle, which allows inferences regarding a relative wind to be drawn.

The outlet may conduct the gas and the refrigerant-gas mixture out of the interior space to a target release point, wherein the target release point is an ignition point at which an ignition of the refrigerant-gas mixture in a targeted manner is providable, or is a safety point at which a risk of ignition of the refrigerant-gas mixture is minimized. Thus, the refrigerant-gas mixture may be guided away from danger points in a targeted manner or a flaring in a targeted manner may be made possible.

The housing may be designed in such a way that it is advantageous with respect to noise, vibration, and harshness (NVH) characteristics.

The housing may consist of or include one or more flameproof materials. Therefore, in the event of a sudden release of refrigerant, the housing may withstand a predetermined internal pressure. Alternatively, the housing may expand on the basis of at least one of the supply of the gas and the escaping refrigerant. The housing may be a balloon or an airbag. In the normal case, the balloon or airbag may rest on the heat pump and expand when the refrigerant escapes. A durability of the housing may be determined on the basis of a refrigerant volume of the heat pump. The balloon or airbag may be designed in such a way that a rigidity at predetermined points on the balloon or airbag is lower in comparison to further points on the balloon or airbag. The further points may be points at which preferably no refrigerant escapes or is supposed to escape and/or no space for the expansion is present. As a result, in the event of an abrupt release, the refrigerant is conducted within the housing in a targeted manner into the regions where it may escape or the housing may inflate.

The safety device may include at least one dehumidifying unit, which reduces moisture and/or dust in the supplied gas, in particular air. In particular, units of the safety device that supply the gas may have such a dehumidifying unit. The dehumidifying unit may be a cyclone unit. By the dehumidifying unit, an introduction of moisture and dirt into the interior space is minimized. The mixing unit may include the dehumidifying unit.

The outlet may generate an acoustic tone or a sequence of acoustic tones on the basis of a predetermined volumetric flow rate of the escaping gas. The outlet may have or be a duckbill.

The problem is solved according to a second aspect by a safety device for a heat pump operated with a flammable refrigerant, in particular propane, including a sealed housing for accommodating the heat pump in such a way that the heat pump is arrangeable within an interior space formed in the housing. The interior space is at least partially filled with an interior space substance which at least partially includes or is at least one of a chemical substance, a protective gas, in particular an inert gas, air, and/or a catalyst. Alternatively, the interior space may have a vacuum. The housing may be, in particular, gas-tight. An overpressure may be present in the interior space. The chemical substance and/or the catalyst reacts with the flammable refrigerant escaping from the heat pump in order to form a non-combustible mixture on the basis of the escaping refrigerant and the chemical substance and/or the catalyst. For this purpose, by an external energy unit and/or an energy unit of the safety device, energy may be provided for activating the reaction of the interior space substance and the refrigerant.

The safety device may also include a gas sensor, which detects a concentration of the refrigerant and/or of the refrigerant in the mixture in the interior space, wherein the gas sensor also outputs a warning signal when the concentration of the refrigerant reaches a predetermined threshold value.

The safety device may also have a collecting line. The collecting line may be a line, a pipe, or a duct. An inlet of the collecting line may be arranged on or at the heat pump. In particular, the inlet of the collecting line may be arranged on or at a predetermined breakage point and/or an outlet valve, in particular a safety valve of the heat pump. The refrigerant escaping from the heat pump may be at least partially accommodated and discharged by the collecting line.

The safety device may have a quiescent zone, wherein the collecting line may conduct the refrigerant to the quiescent zone. In the quiescent zone, a flow rate of the refrigerant may be reduced. Alternatively, or additionally, a pressure of the refrigerant is reduced in the quiescent zone. The quiescent zone may be a second gas-tight housing and/or a chamber within the housing of the safety device. The quiescent zone may become at least partially gas-permeable at a predetermined pressure. In particular, the quiescent zone may have or be a rupture disk, wherein the rupture disk ruptures at a predetermined pressure in such a way that the refrigerant escapes into the interior space of the housing. Alternatively, or additionally, the quiescent zone and/or the collecting line have a safety valve.

The safety device may include an or the outlet. An output of the collecting line and/or the quiescent zone may conduct the refrigerant and/or the mixture to the outlet. The outlet may discharge the refrigerant and/or the mixture from the housing, such that the refrigerant and/or the mixture, when exiting the housing, is mixed with air in such a way that, in particular, a non-combustible mixture is produced. This may be controlled in a closed loop by a closed-loop control of a volumetric flow rate of the refrigerant through the outlet. Alternatively, the refrigerant and/or mixture may be mixed during the release in such a way that a combustible mixture is produced. The combustible mixture may be flared at the output and/or release in a targeted and/or controlled manner.

The safety valve may include an ignition unit, which ignites the refrigerant and/or the mixture outside of the housing.

Features that have been described with respect to the safety device according to the first aspect may be features of the safety device according to the second aspect, and vice versa.

The problem is solved according to a third aspect by a safety system including a safety device according to the first aspect and/or a safety device according to the second aspect, wherein the safety system also includes the heat pump. The heat pump may be arranged in the interior space.

The problem is solved according to a fourth aspect by a vehicle including a safety device according to the first aspect, a safety device according to the second aspect, and/or a safety system according to the third aspect.

### BRIEF DESCRIPTION OF THE DRAWINGS

Preferred exemplary embodiments are explained by way of example on the basis of the accompanying figures. Wherein:

FIG. 1 shows example aspects of a safety system with a safety device according to a first aspect;

FIG. 2 shows second example aspects of a safety system with a safety device;

FIG. 3 shows third example aspects of a safety system with a safety device;

FIG. 4 shows fourth example aspects of a safety system with a safety device;

FIG. 5 shows example aspects of an outlet for a safety device;

FIG. 6 shows fifth example aspects of a safety system with a safety device;

FIG. 7 shows sixth example aspects of a safety system with a safety device; and

FIG. 8 shows example aspects of a vehicle with a safety system.

In the figures, identical or substantially functionally identical or functionally similar elements are labeled with the same reference characters.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

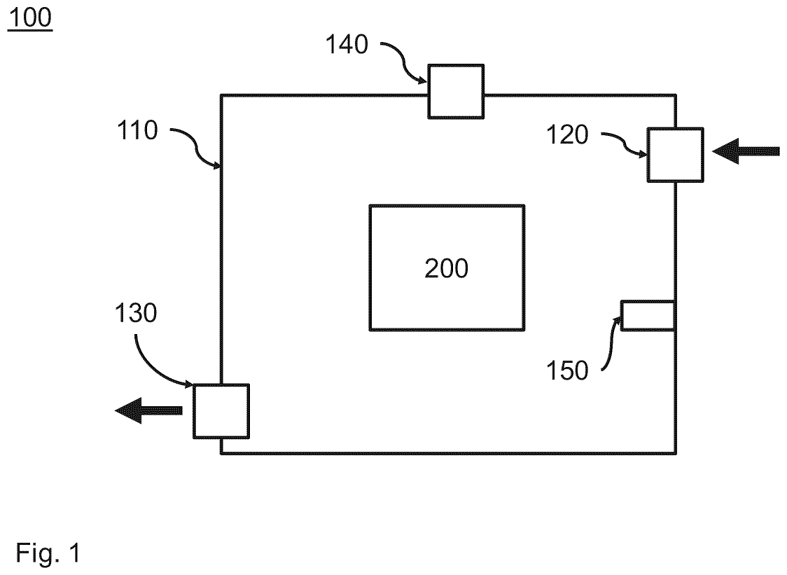

FIG. 1 shows example aspects of a safety system with a safety device 100 according to a first aspect. The safety system is for a heat pump 200 of a vehicle 300 operated with a gaseous flammable refrigerant, in particular propane. Propane is an advantageous refrigerant which, however, when mixed with a gas, in particular air, forms an ignitable mixture and, thus, poses a safety risk. Therefore, it is advantageous to take safety precautions in such a way that, in particular, a non-ignitable refrigerant-gas mixture is produced. Additionally, or alternatively, when an ignitable refrigerant-gas mixture is present, a safe closed-loop control or flaring should be carried out in order to reduce or even eliminate a risk of explosion.

For this purpose, the safety system has the safety device 100 with a housing 110 in which the heat pump 200 is accommodated in such a way that the heat pump 200 is arranged completely in an interior space of the housing 110. The housing 110 has openings for lines to and from the heat pump 200, wherein the openings seal with the lines, in particular in a gas-tight manner. The heat pump 200 has the refrigerant propane.

The safety device 100 also includes at least one mixing unit 120, which supplies a gas, in particular air, to a refrigerant escaping from the heat pump 200 into the interior space. For this purpose, the mixing unit 120 includes or is a valve, which, on the basis of a switching condition of the valve, enables or blocks an entry of air into the interior space. Alternatively, or additionally, the mixing unit 120 includes a fan in order to convey air from the surroundings of the housing 110 into the interior space. In addition, the housing 110 includes inlet valves 140 via which, additionally or alternatively, air is admittable into the interior space. The mixing unit 120 and/or the inlet valve 140 may admit air due to a relative wind of the vehicle 300 into the interior space and/or be connected to a ventilation line of the vehicle 300.

The safety device 100 admits air into the interior space in such a way that a non-ignitable propane-gas mixture is produced in the case of a leak in the interior space. In addition, the safety device 100 includes a gas sensor 150, which measures a concentration of the refrigerant in the interior space. On the basis of the concentration of the refrigerant, the safety device 100 determines the introduction of air in such a way that a non-ignitable mixture is produced. In addition, the gas sensor 150 may output a warning signal, in particular, to the vehicle 300. For example, the vehicle 300 may be stopped on the basis of the warning signal.

In addition, the safety device 100 includes an outlet 130, which is fluid-dynamically connected to the interior space and releases the gas and the refrigerant-gas mixture from the interior space. Therefore, the air and the propane-air mixture is dischargeable from the interior space and a pressure within the housing 110 is regulatable.

The housing 110 has an upper side, a lower side opposite the upper side, and at least one side wall connecting the upper side and the lower side, wherein the outlet 130 is arranged on a left side wall.

As is shown in FIG. 1, the inlet valve 140 is arranged in and/or on the upper side. The outlet 130 is arranged, in FIG. 1, on a left side wall of the housing 110, whereas the mixing unit 120 and the gas sensor 150 are arranged on a right side wall of the housing 110. The invention is not limited thereto and the mixing unit 120, the outlet 130, and/or the gas sensor 150 may be arranged on the same side wall.

By admitting air via the upper side and/or the right side wall, propane is completely mixed with air in the interior space. In addition, the outlet 130 is arranged on a lower section of the left side wall. Due to the arrangement of the outlet 130 on the side, a depth of the installation space of the safety device 100 is advantageously reduced. Since the propane-air mixture is heavier than air, this arrangement makes it possible, in particular, to release the propane-air mixture. The arrows show a flow direction of the air and of the propane-air mixture.

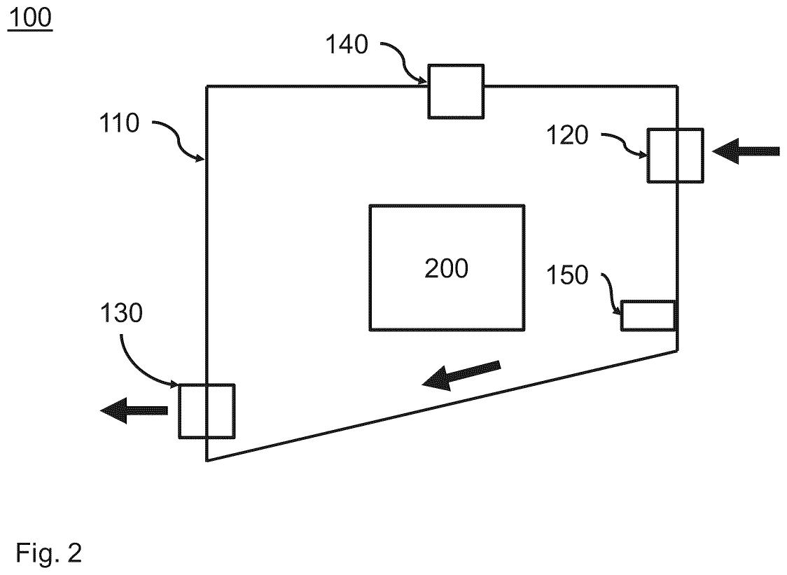

FIG. 2 shows a further exemplary aspects of a safety system with a safety device 100 according to a second aspect. In comparison to FIG. 1, the lower side is not parallel to the upper side, but rather has a downward slope. The lower side is designed in such a way that the propane-air mixture is guided to the outlet 130 by the downward slope. As a result, an accumulation of a propane-air mixture in a section opposite the outlet 130, in this case the right side or the right side wall, is reduced or even prevented.

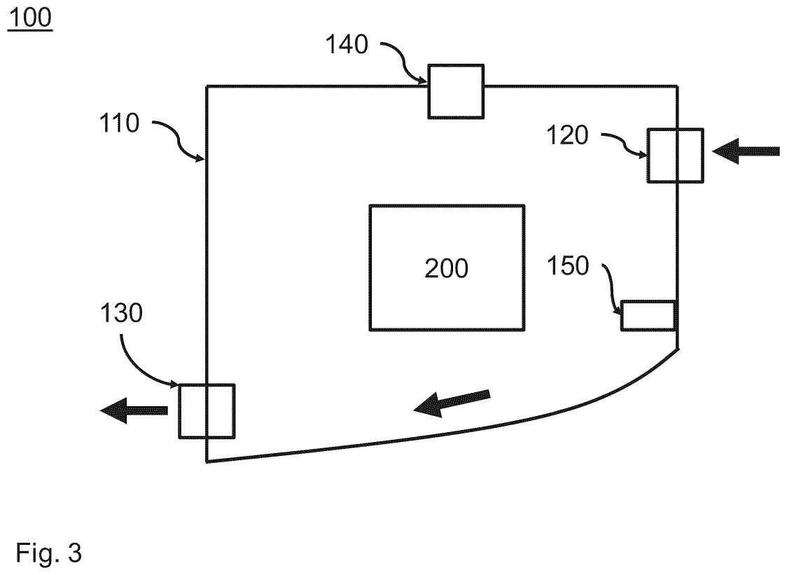

FIG. 3 shows a further exemplary aspect of a safety system with a safety device 100 according to a third aspect. In comparison to FIG. 2, the lower side is arcuate in FIG. 3 in order to conduct the air and the propane-air mixture to the outlet 130.

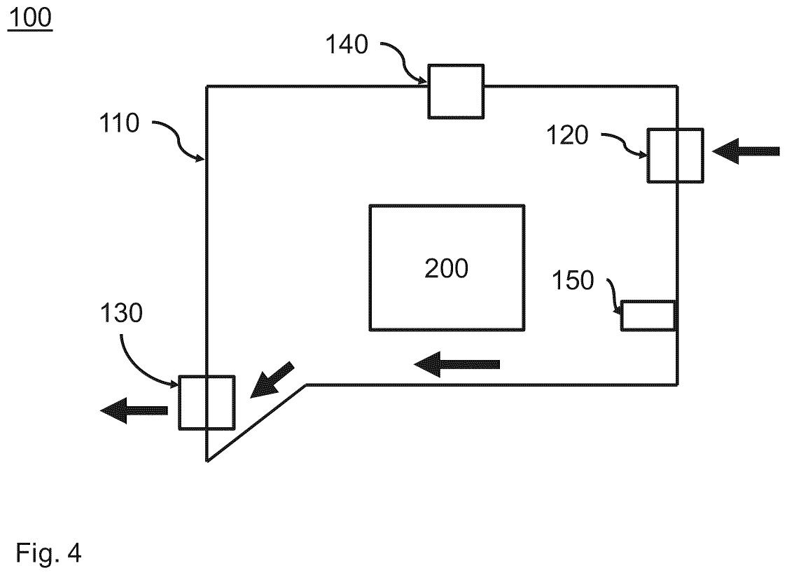

FIG. 4 shows a further exemplary aspect of a safety system with a safety device 100 according to a fourth aspect. In comparison to FIGS. 1 through 3, the lower side in FIG. 4 has a recess, which is connected to the left side wall. The recess therefore forms a type of catch basin. By admitting air via the inlet valve 140 and/or the mixing unit 120, turbulence forms in the interior space. A slower propane-air mixture collects in the recess and is at least partially not further mixed by the turbulence.

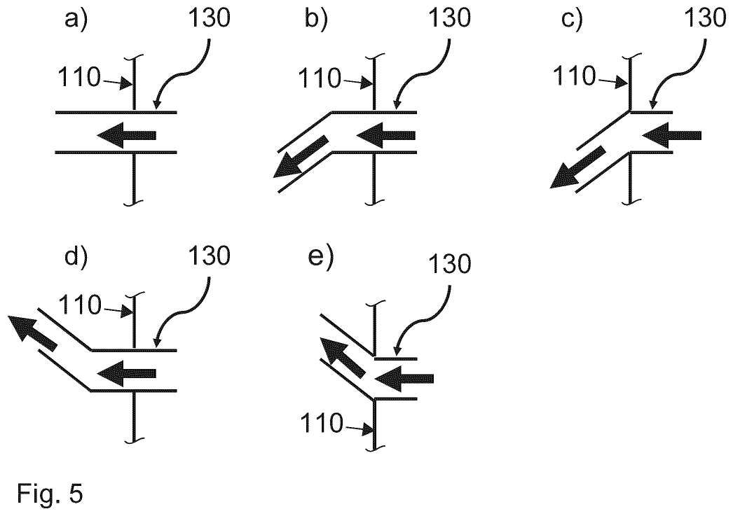

FIG. 5 shows different exemplary aspects of an outlet 130 of the safety devices 100. FIG. 5, example a) shows an outlet 130 which releases the air and the propane-air mixture laterally. FIG. 5, example b) shows an outlet 130 with which the air and the propane-air mixture are initially released from the housing 110 laterally and, subsequently, downward. FIG. 5, example c) shows an outlet with which, in comparison to FIG. 5, example b), the air and the propane-air mixture are released from the housing 110 directly downward. FIG. 5, example d) shows an initial lateral conduction from the housing 110 followed by a conduction of the air and the propane-air mixture upward, whereas FIG. 5, example e) conducts the air and the propane-air mixture from the housing 110 directly upward. The outlet 130 includes or is a duckbill valve, in particular in such a way that a warning tone is generatable when a predetermined volumetric flow rate is reached.

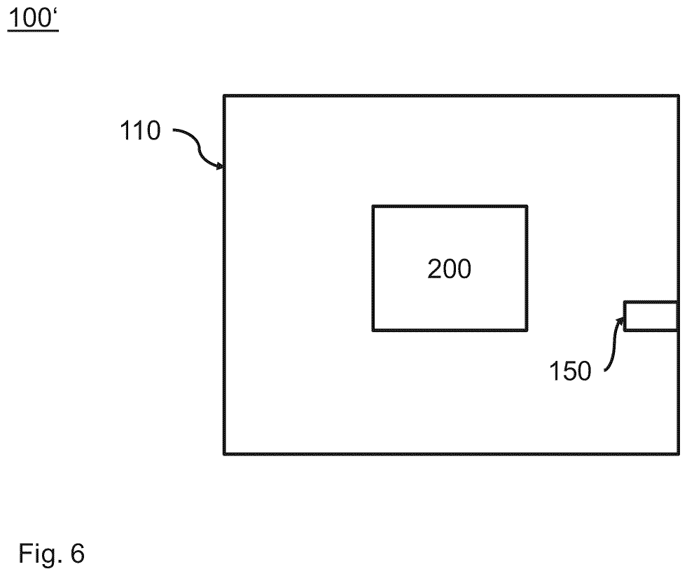

FIG. 6 shows an exemplary aspect of a safety system with a safety device 100′ according to a fifth aspect. In comparison to FIGS. 1 through 4, the safety device 100′ shown in FIG. 6 is closed in a gas-tight manner and does not have an inlet valve, a mixing unit, or an outlet. The interior space has a vacuum for accommodating the propane. Alternatively, the interior space is at least partially filled with the interior space substance, such that a vacuum is partially present or is not present. The interior space substance at least partially includes one of a chemical substance, a protective gas, in particular an inert gas, air, and/or a catalyst. The chemical substance and/or the catalyst reacts with the refrigerant escaping from the heat pump 200 in order to form a non-combustible mixture on the basis of the escaping refrigerant and the chemical substance and/or the catalyst.

By the gas sensor 150, the concentration of the propane and/or the propane in the mixture in the interior space is determined. When a predetermined threshold value of the concentration is exceeded, a warning signal can be output, in particular, to the vehicle 300. In particular, the vehicle 300 may be stopped in response to the warning signal.

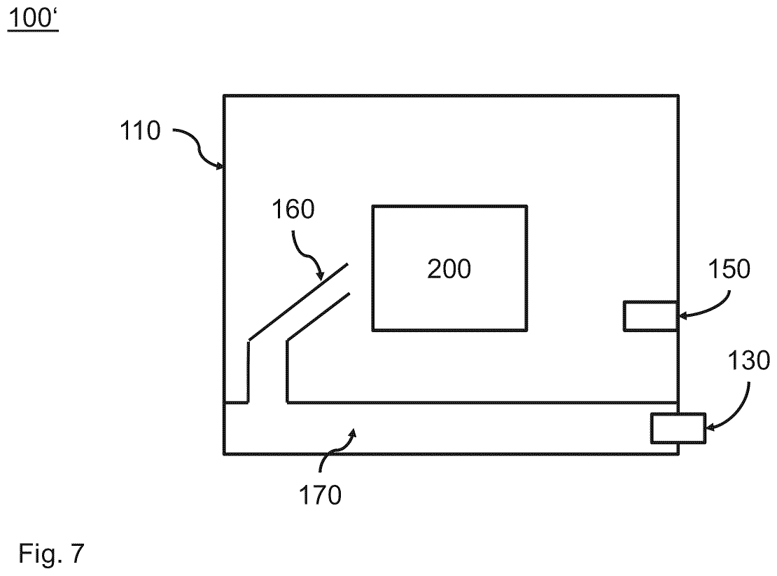

FIG. 7 shows an exemplary aspect of a safety system with a safety device 100′ according to a sixth exemplary aspect. In addition to the safety device 100′ from FIG. 6, the safety device 100′ from FIG. 7 has a collecting line 160, a quiescent zone 170, and an outlet 130. The outlet 130 is arranged, similarly to FIGS. 1 through 4, on a side wall, in this case the right side wall, and on a lower section. In particular, the outlet 130 is arranged within the quiescent zone 170.

The collecting line 160 is arranged in such a way that propane escaping from the heat pump 200 and/or a mixture mixed with the interior space substance is receivable by the capture line 160. The heat pump 200 may have a predetermined breakage point, an emergency venting, and/or a safety valve, wherein an inlet of the collecting line 160 is arranged on the basis of the predetermined breaking point, the emergency venting, and/or the safety valve, in particular in the proximity thereof. The propane may therefore escape from the heat pump 200 and/or form the mixture and be conductible via the collecting line 160 to the quiescent zone 170 at a relatively high flow rate, wherein the quiescent zone 170 reduces the flow rate. For this purpose, the quiescent zone 170 may conduct the flow in a targeted manner and/or have obstacles along a flow direction, which reduce the flow rate. If an interior space substance is not present in the interior space, pure propane is output by the outlet 130 in a controlled manner. For this purpose, the outlet 130 may control the release of the propane in an open loop in such a way that, when emerging from the outlet 130, a mixing with air takes place, in such a way, however, that a non-combustible mixture is produced. Accordingly, the outlet 130 may control a volumetric flow rate of the escaping propane in an open loop.

The exemplary aspects of the safety device 100, 100′ with an outlet 130 conducts the propane-air mixture and/or the propane to a target release point outside of the housing 110. In particular, the target release point may be a point at which a flaring of the propane-air mixture in a targeted manner may be carried out. Alternatively, the propane-air mixture may be guided away from hot sources in order to minimize a risk of ignition.

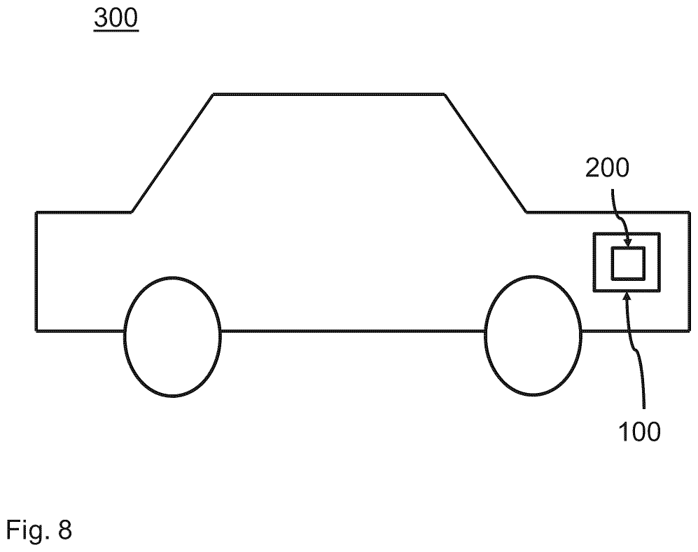

FIG. 8 shows a vehicle 300 with a safety system according to one of the preceding exemplary aspects. By the safety system, the heat pump 100 may be operated with a gaseous flammable refrigerant which is flammable separately and/or when mixed with air under uncontrolled conditions. As a result, the use of such a refrigerant is made possible, safety is increased, and installation space is reduced.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

Reference characters

| | |
|---|---|
| 100, 100′ | safety device |
| 110 | housing |
| 120 | mixing unit |
| 130 | outlet |
| 140 | inlet valve |
| 150 | gas sensor |
| 160 | collecting line |
| 170 | quiescent zone |
| 200 | heat pump |
| 300 | vehicle |

1-16: (canceled)

17. A safety device (100) for a heat pump (200) operated with a flammable refrigerant, the flammable refrigerant comprising propane, the safety device (100) comprising:
a housing (110) having an upper side, a lower side opposite the upper side, and at least one side wall connecting the upper side and the lower side, the heat pump (200) being arrangeable within an interior space defined by the housing (110);
at least one mixing unit (120) for supplying a gas to the flammable refrigerant escaping from the heat pump (200) into the interior space to create a refrigerant-gas mixture, the gas comprising air; and
an outlet (130) arranged on the side wall of the housing (110) and fluid-dynamically connected to the interior space, at least one of the gas and the refrigerant-gas mixture being releasable from the interior space via the outlet.

18. The safety device (100) of claim 17, wherein the outlet (130) is arranged on a lower section of the side wall.

19. The safety device (100) of claim 18, wherein the lower side has a downward slope, the at least one of the gas and the refrigerant-gas mixture being conductible along the lower side to the outlet.

20. The safety device (100) of claim 17, wherein the lower side is at least one of arcuate or planar at least in parts such that the at least one of the gas and the refrigerant-gas mixture is conductible along the lower side to the outlet (130).

21. The safety device (100) of claim 17, wherein one or both of
the mixing unit (120) comprises a first inlet valve; or
the safety device (100) comprises a second inlet valve (140),
wherein one or both of the first inlet valve or the second inlet valve (140) selectively adjusts a supply of the gas to the interior space.

22. The safety device (100) of claim 21, wherein one or both of:
the at least one mixing unit (120) is arranged on an upper section of the side wall or on the upper side; or
the second inlet valve (140) is arranged on the upper section of the side wall or on the upper side.

23. The safety device (100) of claim 17, wherein the mixing unit (120) comprises a Venturi nozzle, the flammable refrigerant escaping from the heat pump (200) being suctioned by the Venturi nozzle and mixed with the gas such that the refrigerant-gas mixture produced is non-combustible.

24. The safety device (100) of claim 17, further comprising:
a gas sensor (150) configured to detect a concentration of the flammable refrigerant in the interior space,
wherein the safety device (100) controls a supply of the gas into the interior space in an open loop based on the concentration of the flammable refrigerant detected in the interior space by the gas sensor (150).

25. The safety device (100) of claim 24, wherein the safety device (100) adjusts the supply of the gas into the interior space by controlling at least one of the at least one mixing unit (120) or a second inlet valve such that the refrigerant-gas mixture produced is non-combustible.

26. The safety device (100) of claim 17, wherein the outlet (130) conducts the at least one of the gas and the refrigerant-gas mixture out of the interior space to a target release point, the target release point being either an ignition point at which the refrigerant-gas mixture is ignitable in a targeted manner or is a safety point at which a risk of ignition of the refrigerant-gas mixture is minimized.

27. The safety device (100) of claim 17, wherein the housing (110) comprises one or more flameproof materials, or
wherein the housing (110) expands based on at least one of a supply of the gas and the flammable refrigerant escaping from the heat pump (200).

28. The safety device (100) of claim 17, wherein the at least one mixing unit (120) comprises at least one dehumidifying unit, the at least one dehumidifying unit reducing at least one of moisture or dust in the gas supplied.

29. A safety system, comprising:
the safety device (100′) of claim 17; and
the heat pump (200).

30. A vehicle (300), comprising the safety system of claim 29.

31. A safety device (100′) for a heat pump (200) operated with a flammable refrigerant, the flammable refrigerant comprising propane, the safety device (100′) comprising:
a sealed housing (110), the heat pump (200) in being arrangeable within an interior space defined by the sealed housing (110), the interior space being at least partially filled with an interior space substance, the interior space substance comprises at least one of a chemical substance, a protective gas, air, or a catalyst, the protective gas being particular an inert gas, the chemical substance and/or the catalyst being reactable with the flammable refrigerant escaping from the heat pump (200) to form a non-combustible mixture.

32. The safety device (100′) of claim 31, further comprising a gas sensor (150) detect a concentration of the flammable refrigerant in the interior space, the gas sensor outputting a warning signal when the concentration of the flammable refrigerant reaches a predetermined threshold value.

33. A safety system, comprising:
the safety device (100′) of claim 31; and
the heat pump (200).

34. A vehicle (300), comprising the safety system of claim 33.
